(19) United States
(12) Patent Application Publication
(10) Pub. No.: US 2008/0140870 A1
(43) Pub. Date: Jun. 12, 2008

(54) Method for Configuring Field Devices

(75) Inventors: Christian Meyer, Laatzen (DE); Stefan Bollmeyer, Minden (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/792,490

(22) PCT Filed: Dec. 23, 2005
(86) PCT No.: PCT/EP05/14009

§ 371 Date: Jun. 7, 2007

(30) Foreign Application Priority Data
Dec. 23, 2004 (DE) 10 2004 062 147.0
Dec. 21, 2005 (DE) 10 2005 061 614.3

(51) Int. Cl. G06F 3/00

(52) U.S. Cl. 710/10

(57) ABSTRACT

A method is disclosed for configuring field devices in a process automation system in which the field devices are connected to other automation components via a field bus. In order to minimize the load on the field bus, the actual configuration of each field device is stored as a copy in a configuration tool, and each change in the configuration initiated on the field device is stored with an unambiguous, structured version ID. In order to update the configuration data and parameter data in the configuration tool, the version ID is transferred into the configuration tool, and the difference between the copy stored in the configuration tool and the new configuration is determined from the structure of said version ID. The difference is retrieved from the respective field device in order to update the configuration data and parameter data in the configuration tool.

The invention relates to a method for configuring field devices in a process automation system.

Modern process automation systems as used in the chemical, petroleum and other process industries employ intelligent field equipment, sensors and actuators. These field devices, as they are known, are connected together and to the rest of the process automation system components via a fieldbus system or other communications installations.

The automation functions, which are essentially control loops, are distributed across these field devices. The potential use in hazardous areas, in particular, places limits on the resources of the field devices for storing the configuration and parameters, and on the transmission bandwidth of the fieldbus systems. A configuration tool having a central configuration database is used for configuring and parameterizing the process automation system. This configuration tool can be used to configure the process automation functions, including the configurations and parameters of the field devices, before any communications link has been established with the field devices (offline configuration). In a subsequent step, the configuration tool is then connected to the fieldbus, and the configurations and parameters are downloaded to the field devices. This download process must include synchronization with data already held in the device, for example preconfigured data.

The configuration is generated on the basis of device description data in order to take into account the specific properties of the field devices. This device description data is normally kept in machine-readable form as a file.

Process automation systems are used for critical, continuous processes, in which the automation function can only be stopped in certain situations. The use of resource-limited field devices on a fieldbus with a highly restricted bandwidth requires special techniques in order to be able to download changes in configuration data and parameter data to the field devices via the fieldbus, even during normal operation, without stopping the automation function.

The object of the invention is to define a method for configuring field devices in the process automation system, wherein the loads placed on the communications links are minimized.

This object is achieved according to the invention by the features of claim 1. Advantageous embodiments of the invention are given in the dependent claims.

The invention is based on a configuration tool having a central configuration database. The invention is also based on field devices that can be configured, and are configured, locally, where it can be provided that the settings are made directly at the field device itself, or via a control unit connected to the field device via a communications link. Said communications link can be formed by a fieldbus.

The configuration tool uses copies of field-device configuration data and parameters, which reflect the most recent download status of the field devices. Such a copy is recorded once only for each field device.

According to a further feature of the invention, in order to check the version of the copies of the configuration data with the field-device data, instead of a complete configuration and parameter comparison, the configuration tool uses version IDs, which either are managed by the field device itself or are changed implicitly by download operations, and hence are used for identifying the configuration held in the field device.

To achieve this, a copy of the current configuration of each field device is initially stored in the configuration tool in a once-only step. By this means, even field devices already integrated in the process automation plant and in operation can subsequently be included in the configuration by means of said configuration tool.

Subsequently, configuration changes and parameter changes from the configuration tool are only transferred as increments to the most recently downloaded configuration.

In detail, it is provided that each local configuration change in the field device is stored with a unique, structured version ID. The version ID is transferred into the configuration tool on request as required, and the structure of the version ID and the stored copy is used to determine the difference, which is retrieved from the respective field device to update the configuration data and parameter data in the configuration tool.

Configuration changes are copied by the configuration tool into the configuration entries and parameter entries of the field devices in such a way as to minimize the impact on the running process automation functions of the whole system, and also to reduce the download operations required until the new configuration in the field devices is obtained.

The increments are generated in the configuration tool on the basis of copies of field-device configuration data. The increments are chosen here so as to minimize the impact on the process controlled by the system and also to minimize the transmission times by changes being as small as possible.

The generated configuration may use, for implementing the same automation function, more configuration entries than a configuration that does not take account of the current configuration of the field devices. This means, however, that the download operations required to obtain the new configuration in the field devices can be reduced, and the impact on the process automation function of the whole system can be minimized.

By means of the method described here, changes that were made at the field devices can be incrementally synchronized with the data held in the configuration database without needing to interrupt the process automation function of the whole system.

According to a further feature of the invention, it is provided that the version IDs are managed by each field device itself, or are changed implicitly by download operations.

In a preferred embodiment of the invention, the version IDs are graded. The grading is based on the knowledge that a device configuration for a modern, complex field device has a certain detectable granularity that is reflected in properties of objects. In this case it is provided that, in addition to the situation where the whole configuration has changed, the change in objects is also identified if at least one property has changed.

The extent of the as-required update of the configuration data and parameter data is determined dynamically from the grades of the version IDs by establishing those objects whose properties have been changed. This advantageously simplifies the process of determining the required update extent.

1. A method for configuring field devices in a process automation system, in which the field devices are connected to other automation components via a fieldbus, which makes use of a configuration tool,
wherein
a copy of the current configuration of each field device is stored in the configuration tool in a once-only step,
and the following steps are repeated recursively:
a. storing the new configuration in the field device and assigning a unique, structured version ID,
b. transferring the version ID into the configuration tool,
c. using the structure of the version ID to determine the difference between the copy stored in the configuration tool and the new configuration of the same field device, and
d. retrieving from the respective field device the determined difference for updating the configuration data and parameter data in the configuration tool.

2. The method as claimed in claim 1,
wherein
the version IDs are managed by each field device itself and are changed implicitly by download operations.

3. The method as claimed in claim 1,
wherein
the version IDs are graded, and the extent of the as-required update of the configuration data and parameter data is determined dynamically from the grades of the version IDs.

4. The method as claimed in claim 2, wherein the version IDs are graded, and the extent of the as-required update of the configuration data and parameter data is determined dynamically from the grades of the version IDs.

5. A method for configuring at least one field device, each field device having a respective configuration stored in a configuration tool, comprising:
a. storing a new configuration in the at least one field device and assigning a unique, version ID,
b. transferring the version ID into the configuration tool,
c. determine a difference between the respective configuration stored in the configuration tool and the new configuration of the at least one field device based on the version ID, and
d. retrieving from the at least one field device the determined difference for updating configuration data and parameter data in the configuration tool.
